(19) United States
(12) Patent Application Publication
(10) Pub. No.: US 2012/0194471 A1
(43) Pub. Date: Aug. 2, 2012

(54) DEVICE HAVING TOUCH SCREEN AND METHOD FOR CHANGING TOUCH MODE THEREOF

(75) Inventors: Jong Dae PARK, Suwon-si (KR); Hoon Do HEO, Suwon-si (KR); Heon Seok LEE, Suwon-si (KR)

(73) Assignee: SAMSUNG ELECTRONICS CO. LTD., Suwon-si (KR)

(21) Appl. No.: 13/358,933

(22) Filed: Jan. 26, 2012

(30) Foreign Application Priority Data
Jan. 27, 2011 (KR) 10-2011-0008094

(51) Int. Cl. G06F 3/044

(52) U.S. Cl. 345/174

(57) ABSTRACT

An apparatus and method for changing a touch mode in a device having a touch screen including a plurality of touch sensors is provided. In a method for changing a touch mode in the device, the device determines a variation in the influx of electric charges during a time period in a charging process, and determines whether the variation exceeds a given critical value. If the variation exceeds the critical value, the device operates the touch screen in a self capacitive touch mode using the touch sensors as sending ends for sending the electric charges in order to detect a touch event. Therefore, the device of a mutual capacitive touch type can detect a touch event by using the self capacitive touch mode even in unstable power environments.

### PRIORITY

This application claims the benefit under 35 U.S.C. §119(a) of a Korean patent application filed on Jan. 27, 2011 in the Korean Intellectual Property Office and assigned Serial No. 10-2011-0008094, the entire disclosure of which is hereby incorporated by reference.

### BACKGROUND OF THE INVENTION

1. Field of the Invention

The present invention relates to a device having a touch screen with a changeable touch mode. More particularly, the present invention relates to a touch mode changeable device and a method for changing a touch mode of the device according to variations in the surrounding environment.

2. Description of the Related Art

A touch screen is a type of input device in which a touch sensor is attached to a display layer. The touch screen is mainly used for small-sized devices such as a mobile device or a portable device. In case of a small device, the touch screen is very useful as an input unit for entering letters or for selecting menus due to an easy input action and a shortage of space for input units in the device.

The touch screen detects a user's input action through a touch sensor based on various sensing types such as a capacitive type, a resistive type, an infrared type, and the like. Among them, a capacitive type is widely used since it has a high touch reaction speed, a low error rate, a long life, and a high transmission rate.

In the touch screen of the capacitive type, a mutual capacitive touch technique allows a multi-touch operation where multiple fingers can be accurately tracked at the same time. Normally, a mutual capacitive touch technique is better than a self capacitive touch technique which allows only a single touch operation. However, the mutual capacitive touch technique is susceptible to power noise. Therefore, when an incompatible charger is used to charge the device or when a charging process is carried out under an insecure power supply environment, a mutual capacitive touch device may experience unexpected errors such as a ghost touch in which the device mistakenly recognizes a touch event in spite of no actual touch, an incorrect sensing in which the device incorrectly identifies a touch position, or a non-sensing in which the device fails to detect a touch.

### SUMMARY OF THE INVENTION

Aspects of the present invention are to address the above-mentioned problems and/or disadvantages and to provide at least the advantages described below. Accordingly, an aspect of the present invention is to provide a method for changing a touch mode of a device having a touch screen.

Another aspect of the present invention is to provide a device having a touch screen and allowing a change of a touch mode.

In accordance with an aspect of the present invention, a method for changing a touch mode in a device having a touch screen composed of a plurality of touch sensors is provided. The method includes determining a variation in the influx of electric charges during a time period in a charging process, determining whether the variation exceeds a given critical value, and, if the variation exceeds the critical value, operating the touch screen in a self capacitive touch mode using the touch sensors as sending ends for sending the electric charges in order to detect a touch event.

In accordance with another aspect of the present invention, a touch mode changeable device is provided. The device includes a touch screen composed of a plurality of touch sensors for detecting a touch event, a noise determining unit for determining a variation in the influx of electric charges during a time period in a charging process and for determining whether the variation exceeds a given critical value, and a control unit for, if the variation exceeds the critical value, operating the touch screen in a self capacitive touch mode using the touch sensors as sending ends for sending the electric charges in order to detect the touch event.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will be more apparent from the following description taken in conjunction with the accompanying drawings, in which:

FIG. 1 is a block diagram illustrating a configuration of a device according to an exemplary embodiment of the present invention.

FIG. 2 is a schematic view illustrating a self capacitive touch mode according to an exemplary embodiment of the present invention.

FIG. 3 is a schematic view illustrating a touch screen based on a mutual capacitive touch type according to an exemplary embodiment of the present invention.

FIG. 4 is a schematic view illustrating a mutual capacitive touch mode according to an exemplary embodiment of the present invention.

FIG. 5 is a schematic view illustrating a changed touch mode according to an exemplary embodiment of the present invention.

FIG. 6 is a flowchart illustrating a method for changing a touch mode according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Among the various terms set forth herein, a touch event refers to the presence of an input tool such as a finger or a stylus pen on the surface of a touch screen.

A self capacitive touch mode refers to a specific mode in which a touch sensor having charge-sending ends detects a touch event from the quantity of charges stored in a capacitor.

A mutual capacitive touch mode refers to a specific mode in which a touch sensor having charge-sending ends and charge-receiving ends detects a touch event by comparing an amount of charge received at the charge-receiving ends with that sent from the charge-sending ends.

A device refers to any electronic device that has a touch screen of a capacitive type, including a mobile communication device, a handheld phone, a Digital Multimedia Broadcast (DMB) receiver, a Personal Digital Assistant (PDA), or a smart phone.

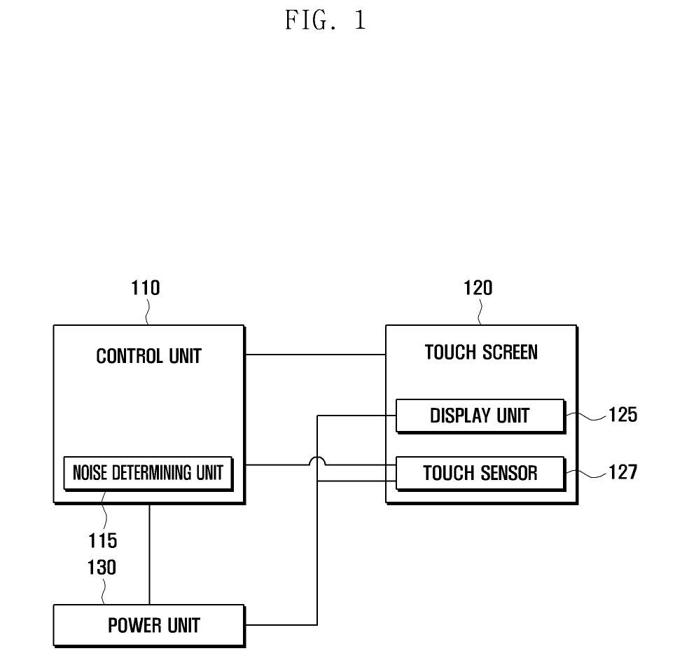

FIG. 1 is a block diagram illustrating the configuration of a device according to an exemplary embodiment of the present invention.

Referring to FIG. 1, the device includes a control unit 110, a touch screen 120, and a power unit 130.

The control unit 110 controls operations and the flow of signals between internal blocks of the device and may also perform data processing. More particularly, the control unit 110 can control a mode for detecting a touch event by controlling the touch screen 120 according to power-related environments of the device. More specifically, when a mode in which the touch screen 120 detects a touch event is a mutual capacitive touch mode, the control unit 110 determines power-related environments of the device. Namely, by controlling the power unit 130, the control unit 110 determines whether an incompatible charger is used or whether a charging procedure is carried out under an insecure power supply environment.

Also, the control unit 110 determines whether a power environment of the device is unstable. For this, the control unit 110 includes a noise determining unit 115.

The noise determining unit 115 controls the power unit 130 and determines the amount of electricity that is applied to the power unit 130 during a charging operation. Here, the noise determining unit 115 determines whether the influx of electricity is uniform or varied. Namely, the noise determining unit 115 determines a variation in the amount of electricity provided over a certain period of time. Additionally, the noise determining unit 115 determines whether the determined variation exceeds a given critical value.

In case of an unstable power environment, the control unit 110 changes a touch mode of the touch screen 120 from a mutual capacitive touch mode to a self capacitive touch mode. Namely, if the determined variation exceeds the given critical value, the control unit 110 concludes that the power environment of the device is unstable. The control unit 110 connects a sending end to a capacitor through a switch in order to change a mutual capacitive touch mode to a self capacitive touch mode. And, the control unit 110 controls a receiving end so that it may send electric charges like a sending end.

In a mutual capacitive touch mode capable of detecting a multi-touch event, a sending end sends electric charges and a receiving end receives a reduced number of charges. A touch event is detected by determining the amount of reduction in charges. In a self capacitive touch mode, a sending end sends electric charges and a touch event is detected by determining the amount of charge stored in a capacitor. Therefore, when a mutual capacitive touch mode is changed to a self capacitive touch mode, a receiving end performs a function of sending electric charges as if it were a sending end.

After a mutual capacitive touch mode is changed to a self capacitive touch mode, the touch screen 120 determines whether electric charges are increased at a receiving end and thereby detects a touch event. Additionally, the touch screen 120 may detect a touch event by determining the amount of charge stored in a capacitor at a sending end connected to the capacitor through a switch.

On the other hand, in a case in which a current power environment of the device is not unstable, the control unit 110 maintains a mutual capacitive touch mode. Also, the control unit 110 may periodically determine a power environment of the device and may change a touch mode of the touch screen 120 from a mutual capacitive touch mode to a self capacitive touch mode or vice versa. Namely, if a power environment of the device becomes unstable in a mutual capacitive touch mode, the control unit 110 enters into a self capacitive touch mode. Similarly, if a power environment of the device becomes stable in a self capacitive touch mode, the control unit 110 enters into a mutual capacitive touch mode.

The touch screen 120 is composed of a display unit 125 and a touch sensor 127 disposed near the display unit 125. The display unit 125 displays any information input by a user or offered to a user such as various menus of the device. The display unit 125 may be formed of a Liquid Crystal Display (LCD) or any other equivalent.

The touch sensor 127 is attached to the display unit 125 and can detect a touch event that occurs on the surface of the display unit 125. Also, the touch sensor 127 can detect a location, i.e., coordinates, of a touch event. The touch sensor 127 may employ a capacitive type, an ultrasonic reflection type, an optical sensor and electromagnetic induction type, etc. The touch sensor 127 in this disclosure is a capacitive type and can selectively operate in a mutual capacitive touch mode or in a self capacitive touch mode.

The power unit 130 supplies electric power to elements of the device under the control of the control unit 110. The power unit 130, which may include a battery, can be charged by means of an external source of electricity.

As discussed above, the device changes a mutual capacitive touch mode to a self capacitive touch mode in the event of an unstable power environment, thus preventing unexpected errors of the touch screen.

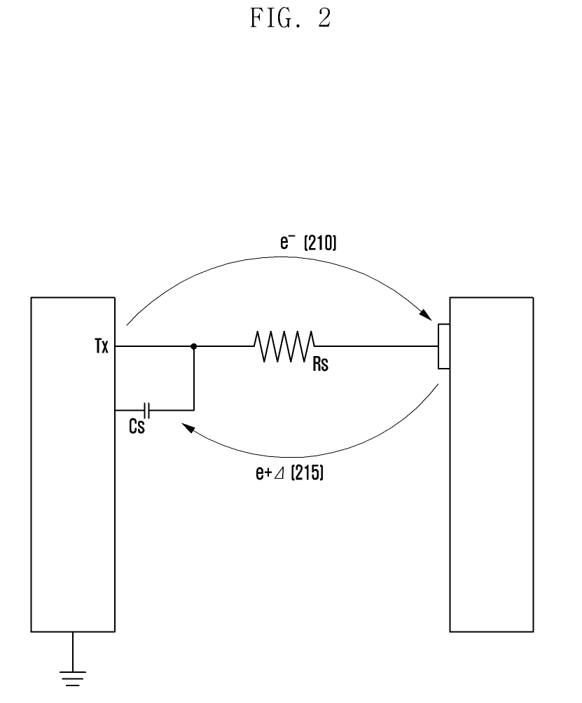

FIG. 2 is a schematic view illustrating a self capacitive touch mode according to an exemplary embodiment of the present invention.

Referring to FIG. 2, a self capacitive touch mode detects a touch event by using a process of storing electric charges, sent from a sending end, in a receiving end. More specifically, while electric charges 210 are continuously sent from a sending end in a self capacitive touch mode, the touch screen 120 can detect a touch event depending on the amount of charges 215 stored in a capacitor and further depending on how fast the charges 215 are stored up to a given point.

In a self capacitive touch mode, each of base nodes that constitute the touch sensor 127 of the touch screen 120 performs a role as an independent sensor. Furthermore, a self capacitive touch mode determines the removal of a touch event by determining the time when charges are discharged from a capacitor. In a self capacitive touch mode, any noise caused by unstable power or the like does not affect the detection of a touch event.

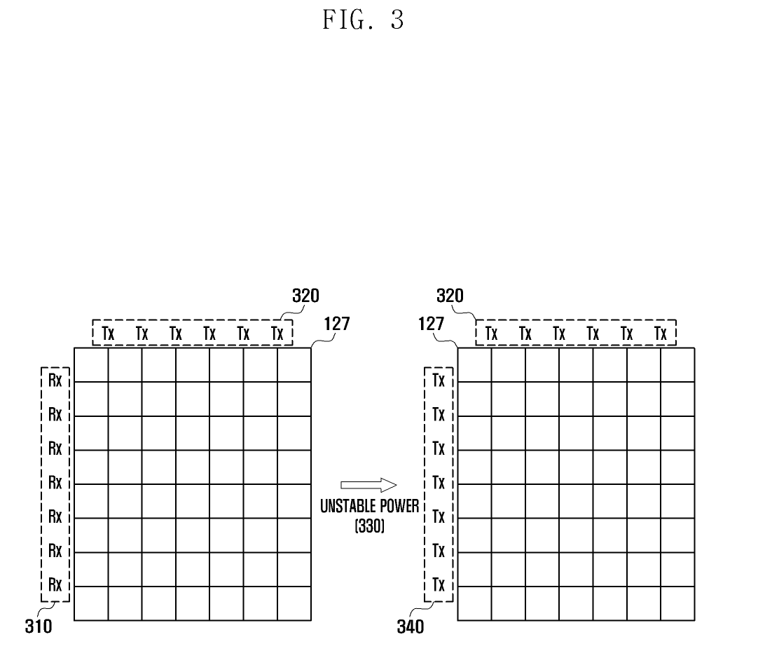

FIG. 3 is a schematic view illustrating a touch screen based on a mutual capacitive touch type according to an exemplary embodiment of the present invention.

Referring to FIG. 3, the touch screen 120 based on a mutual capacitive touch type has a plurality of sending ends 310 that send electric charges and a plurality of receiving ends 320 that receive electric charges from the sending ends 310. Additionally, the touch screen 120 is formed having a matrix structure.

If it is determined that power is unstable 330 in a mutual capacitive touch mode, the touch screen 120 converts all of the receiving ends 310 into sending ends 340. During this conversion, the touch screen 120 supplies electric charges to the receiving ends 310. The receiving ends 310 converted into the sending ends 340 continuously send supplied charges. When any touch event occurs, the touch screen 120 can detect the occurrence of such a touch event according to the amount of charges stored in capacitors of the sending ends 320 and 340.

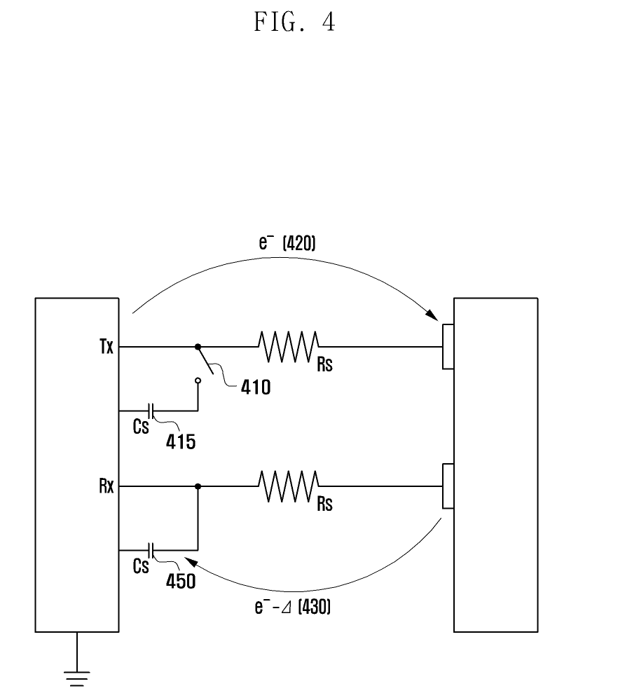

FIG. 4 is a schematic view illustrating a mutual capacitive touch mode according to an exemplary embodiment of the present invention.

Referring to FIG. 4, in a mutual capacitive touch mode, touch sensors of the touch screen 120 are composed of sending ends and receiving ends. The touch sensors have transmission lines and capacitors 415 and 450. The capacitors 415 and 450 are connected to the transmission lines for sending electric charges and thus store such charges. The sending end of the touch sensor has a switch 410. In a mutual capacitive touch mode, the switch 410 disconnects the capacitor 415 from the transmission line. That is, in the mutual capacitive touch mode, the switch 410 is turned off or ‘opened’ to electrically disconnect the capacitor from the transmission line. When the receiving end is converted into the sending end due to an unstable power, the switch 410 is turned on and connects with the capacitor 415 in order to operate in a self capacitive touch mode.

The sending ends send the same amount of charges 420 to the receiving ends. Each receiving end receives charges 430 and determines a reduced amount of the received charges 430. Namely, a mutual capacitive touch mode detects a touch event by determining a reduction in the number of charges received at the receiving ends. The touch screen 120 of a mutual capacitive touch mode is composed of sensors arranged in a matrix form. Namely, the touch screen 120 of a mutual capacitive touch mode sends electric charges at the sending ends, i.e., the X-line, and receives such charges at the receiving ends, i.e., the Y-line, thus allowing the detection of a multi-touch. Also, this increases the efficiency of the touch sensors 127 according to matrix principles.

The touch screen 120 of a mutual capacitive touch mode recognizes a touch event by determining the amount of charges taken by any conductor such as fingers or a stylus pen. However, if any noise is caused in the sending ends, the touch screen 120 may not detect a touch event or operate improperly. In order to address this problem, the touch screen 120 can change a mutual capacitive touch mode to a self capacitive touch mode in case of an unstable power environment.

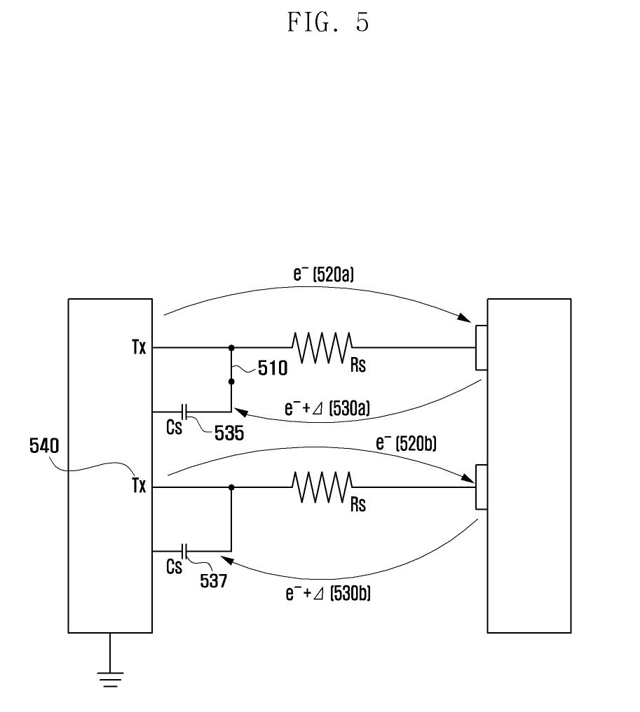

FIG. 5 is a schematic view illustrating a changed touch mode according to an exemplary embodiment of the present invention.

Referring to FIG. 5, when power is unstable, a mutual capacitive touch mode is changed to a self capacitive touch mode. Namely, the touch screen 120 changes a mutual capacitive touch mode in which a touch event is detected through the sending ends and the receiving ends to a self capacitive touch mode in which a touch event is detected through the sending ends only. In a self capacitive touch mode, the touch sensors of the touch screen 120 are used as the sending ends. Each touch sensor has a transmission line and a capacitor. The capacitor is connected to the transmission line for sending electric charges and thus stores such charges. Additionally, the touch sensor has a switch 510. In a self capacitive touch mode, the switch 510 connects the capacitor to the transmission line.

When a mutual capacitive touch mode is changed to a self capacitive touch mode, the sending end is connected to a capacitor 535 through the switch 510. Therefore, the sending end converted from the receiving end can operate in a self capacitive touch mode.

The sending end continuously sends electric charges 520a. When a touch event occurs, the touch screen 120 detects a touch event depending on the amount of charges 530a stored in the capacitor 535 and further depending on how fast the charges 530a are stored up to a given point. Additionally, another sending end converted from the receiving end sends electric charges 520b. When a touch event occurs, the touch screen 120 detects a touch event depending on the amount of charges 530b stored in a capacitor 537 and further depending on how fast the charges 530b are stored up to a given point.

A device in a self capacitive touch mode is less susceptible to noise than the device in a mutual capacitive touch mode. In the case of a self capacitive touch mode, electric charges are continuously accumulated in the capacitor even though a touch event occurs. Therefore, the amount of stored charge is considerably greater than any noise, so the effect of noise may be negligible. Contrary to that, a mutual capacitive touch mode determines a reduction in charges in comparison with sent charges in order to detect a touch event. Unfortunately, since noise may cause an increase of electric charges, the effect of noise may be critical.

For example, when the number of bursts indicating noise is about 100˜1000 times, the number of bursts indicating electric charges in a mutual capacitive touch mode is about 63 times. Since the number of noise bursts is relatively greater, any noise in any burst section may be crucial in a mutual capacitive touch mode.

Since a self capacitive touch mode merely detects a single touch event, each node forming the touch sensor 127 can independently operate. In other words, it is possible to remove noise in a self capacitive touch mode by comparing a signal of a node detecting a current touch event with signals of neighboring nodes. However, it is difficult to remove noise in a mutual capacitive touch mode since it detects a multi-touch event by using a matrix structure. Therefore, if there is a considerable amount of noise due to an unstable power environment, a touch mode of the touch screen 120 is changed from a mutual capacitive touch mode to a self capacitive touch mode in order to reduce the possibility of incorrect operation.

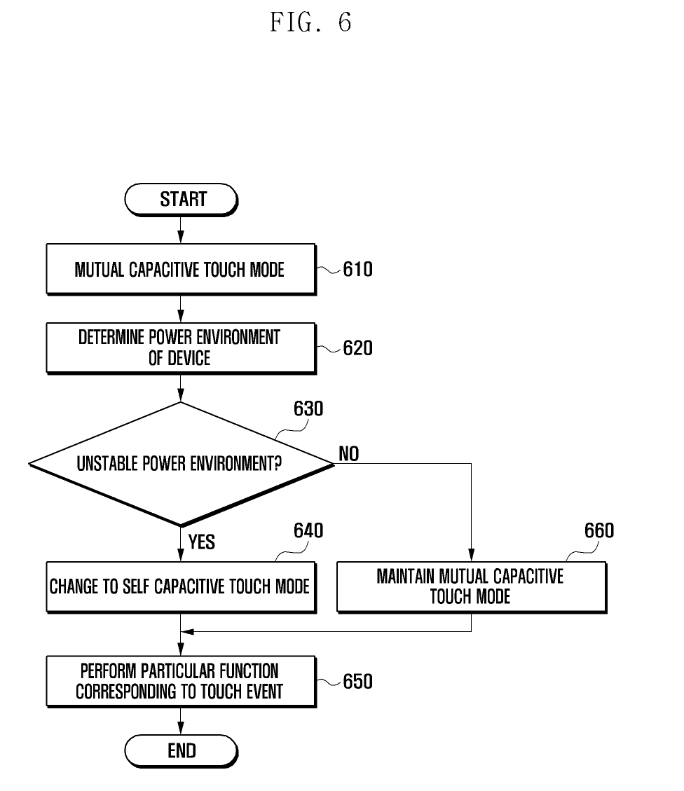

FIG. 6 is a flowchart illustrating a method for changing a touch mode according to an exemplary embodiment of the present invention.

Referring to FIG. 6, when the touch screen 120 is in a mutual capacitive touch mode in step 610, the control unit 110 determines a power environment of the device in step 620. For example, during a charging process, the control unit 110 determines a variation in the amount of charges according to time. For instance, the control unit 110 determines whether an incompatible charger is used or whether a charging process is carried out in an environment using a low quality power supply.

The control unit 110 determines whether a power environment of the device is unstable in step 630. In an exemplary implementation, the control unit 110 determines whether the influx of charges is uniform or varied. Namely, the control unit 110 determines whether the determined variation exceeds a given critical value.

In it is determined in step 630 that the power environment is unstable, the control unit 110 changes a touch mode of the touch screen 120 from a mutual capacitive touch mode to a self capacitive touch mode in step 640. Namely, if the variation exceeds the given critical value, the control unit 110 concludes that the power environment of the device is unstable. The control unit 110 connects a sending end to a capacitor through a switch by controlling the touch screen 120 in order to change a mutual capacitive touch mode to a self capacitive touch mode. And, the control unit 110 controls the touch screen 120 so that a receiving end may send electric charges like a sending end. Connecting a sending end to a capacitor in order to change a touch mode is exemplary only and not to be considered as a limitation of the present invention. Alternatively, when a mutual capacitive touch mode is changed to a self capacitive touch mode, the control unit 110 may shut off power supplied to a sending end and detect a touch event through another sending end converted from a receiving end.

In a mutual capacitive touch mode, a receiving end determines a reduction in the number of charges in comparison with the number of charges sent from a sending end. Depending on the time when charges are stored in a capacitor up to a given point, the receiving end can detect a touch event. However, in a self capacitive touch mode, a sending end determines the amount of charges stored in a capacitor. Depending on the time when charges are stored in a capacitor up to a given point, the sending end can detect a touch event. Therefore, when a mutual capacitive touch mode is changed to a self capacitive touch mode, the touch screen 120 detects a touch event by determining whether the amount of charges determined at the receiving end converted into the sending end is increased.

The control unit 110 performs a particular function corresponding to the detected touch event in step 650. On the other hand, if it is determined in step 630 that the current power environment of the device is not unstable, the control unit 110 maintains a mutual capacitive touch mode in step 660. Namely, if the variation does not exceed the given critical value, the control unit 110 concludes that a power environment of the device is not unstable.

Although not illustrated in the drawings, the control unit 110 may periodically determine a power environment of the device and may change a touch mode of the touch screen 120 from a mutual capacitive touch mode to a self capacitive touch mode or vice versa. Namely, if a power environment of the device becomes unstable in a mutual capacitive touch mode, the control unit 110 enters into a self capacitive touch mode. Similarly, if a power environment of the device becomes stable in a self capacitive touch mode, the control unit 110 enters into a mutual capacitive touch mode.

When the mutual capacitive touch mode is changed to a self capacitive touch mode, the sending end is not always connected to a capacitor through a switch. Alternatively, when the mutual capacitive touch mode is changed to a self capacitive touch mode, the control unit 110 may disregard the amount of charges determined at the sending end by controlling the touch screen 120. The control unit 110 may detect a touch event through the amount of charges determined at the receiving end converted to the sending end. Furthermore, the control unit 110 may shut off power supplied to the sending end and detect a touch event through the receiving end converted to the sending end.

As fully discussed heretofore, the device of a mutual capacitive touch type can detect a touch event by using a self capacitive touch mode even in unstable power environments. Additionally, even though an incompatible charger is used or power is supplied unstably, the device of a mutual capacitive touch type can detect a touch event without errors through a touch mode change to a self capacitive touch mode.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for changing a touch mode in a device having a touch screen including a plurality of touch sensors, the method comprising:
determining a variation in the influx of electric charges during a time period in a charging process;
determining whether the variation exceeds a given critical value; and
if the variation exceeds the critical value, operating the touch screen in a self capacitive touch mode using the touch sensors as sending ends for sending the electric charges in order to detect a touch event.

2. The method of claim 1, wherein the operating of the touch screen in the self capacitive touch mode comprises changing a mutual capacitive touch mode to the self capacitive touch mode when the touch screen operates in the mutual capacitive touch mode using first parts of the touch sensors as the sending ends and using second parts of the touch sensors as receiving ends for receiving the electric charges.

3. The method of claim 2, wherein the changing of the mutual capacitive touch mode to the self capacitive touch mode comprises converting the second parts of the touch sensors into the sending ends.

4. The method of claim 3, wherein each of the touch sensors comprises a transmission line for sending the electric charges from the sending end, and a capacitor connected to the transmission line for storing the electric charges, and wherein each of the second parts of the touch sensors further includes a switch for connecting the transmission line and the capacitor.

5. The method of claim 4, wherein the switch connects the transmission line and the capacitor in the self capacitive touch mode, and wherein the sending end detects the touch event according to a time when the amount of the electric charges stored in the capacitor reaches a given point in the self capacitive touch mode.

6. The method of claim 4, wherein the switch disconnects the capacitor from the transmission line in the mutual capacitive touch mode, and wherein the receiving end detects the touch event according to a time when the amount of the electric charges stored in the capacitor reaches a given point in the mutual capacitive touch mode.

7. The method of claim 1, further comprising, if the variation does not exceed the critical value, operating the touch screen in a mutual capacitive touch mode.

8. The method of claim 1, further comprising:
after the operating of the touch screen in the self capacitive mode, determining whether the variation continues to exceed the given critical value; and
if the variation does not continue exceed the critical value, operating the touch screen in a mutual capacitive touch mode.

9. A touch mode changeable device comprising:
a touch screen composed of a plurality of touch sensors for detecting a touch event;
a noise determining unit for determining a variation in the influx of electric charges during a time period in a charging process and for determining whether the variation exceeds a given critical value; and
a control unit for, if the variation exceeds the critical value, operating the touch screen in a self capacitive touch mode using the touch sensors as sending ends for sending the electric charges in order to detect the touch event.

10. The device of claim 9, wherein the control unit changes a mutual capacitive touch mode to the self capacitive touch mode when the touch screen operates in the mutual capacitive touch mode using first parts of the touch sensors as the sending ends and using second parts of the touch sensors as receiving ends for receiving the electric charges.

11. The device of claim 10, wherein the control unit converts the second parts of the touch sensors into the sending ends.

12. The device of claim 11, wherein each of the touch sensors comprises a transmission line for sending the electric charges from the sending end, and a capacitor connected to the transmission line for storing the electric charges, and wherein each of the second parts of the touch sensors further includes a switch for connecting the transmission line and the capacitor.

13. The device of claim 12, wherein the switch connects the transmission line and the capacitor in the self capacitive touch mode, and wherein the sending end detects the touch event according to a time when the amount of the electric charges stored in the capacitor reaches a given point in the self capacitive touch mode.

14. The device of claim 12, wherein the switch disconnects the capacitor from the transmission line in the mutual capacitive touch mode, and wherein the receiving end detects the touch event according to a time when the amount of the electric charges stored in the capacitor reaches a given point in the mutual capacitive touch mode.

15. The device of claim 9, wherein, if the variation does not exceed the critical value, the control unit operates the touch screen in a mutual capacitive touch mode.

16. The device of claim 9, wherein, after operating the touch screen in the self capacitive mode, the control unit determines whether the variation continues to exceed the given critical value, and, if the variation does not continue exceed the critical value, the control unit operates the touch screen in a mutual capacitive touch mode.
